(19) United States
(12) Patent Application Publication
(10) Pub. No.: US 2004/0124629 A1
(43) Pub. Date: Jul. 1, 2004

(54) Game pieces with rails containing prize-validity information

(76) Inventors: Mark D. Davis, Alpharetta, GA (US); Robert L. Everett, Sugar Hill, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/334,443

(22) Filed: Dec. 30, 2002

(51) Int. Cl. B42D 15/00

(52) U.S. Cl. 283/81

(57) ABSTRACT

Multi-ply labels with validity information are addressed. The validity information typically is included in the area of the rails of one or more plies, notwithstanding that adhesive might also be contained in these areas. The validity information additionally may be viewable (rather than hidden or wholly confused) when the labels are candled, facilitating determination of validity of a game piece within a label without separating or destroying the plies.

### FIELD OF THE INVENTION

This invention relates to label structures and more particularly to labels, principally (although not exclusively) in the form of game pieces in which prize-validity information is contained on the rails of the game pieces.

### BACKGROUND OF THE INVENTION

Commonly-owned U.S. Pat. No. 5,944,355 to Rich, et al., hereby incorporated in its entirety by this reference, discloses embodiments of multi-ply promotional labels. At least one such label structure contains three plies: a base ply typically designed to be attached to a substrate, a second ply coupled to the base ply, and a third ply coupled to the second ply. As depicted in FIGS. 1A-1B of the Rich patent, each ply optionally may be divided into a central section separating two rails, with perforations defining the boundaries of the central section and each rail adjacent thereto. Although preferably the components of the base ply are never separated, those of the second and third plies advantageously are separated by consumers; to do so, they need merely grasp the (overlaid) central sections of the second and third plies and pull them away from the substrate, thus rupturing the perforations. Following this action, typically remaining on the substrate is the entirety of the base ply plus all rails of the second and third plies.

These versions of labels illustrated in the Rich patent often contain game indicia printed on the undersides of the second plies. Non-limiting examples of such indicia may include phrases such as “You Have Won” (some sort of prize) or a game piece for use on a board. Those skilled in the relevant art will, of course, recognize that the types of game indicia available to be included on the second plies is effectively unlimited. External faces of the third plies often contain promotional or game-related information (e.g. “Play and Win”), although they need not necessarily do so, nor need they necessarily contain any particular such information. Likewise, undersides of the third plies and faces of the second plies may contain either legitimate (game-related) information or, if desired, any of various types of confusion patterns designed to reduce visibility (or intelligibility) of the game indicia, through candling or other techniques, after application of the labels to a substrate but prior to separation of the plies by consumers.

Because the central sections of the second and third plies are designed to be separable from both each other and the base ply, coupling of plies of the labels of the Rich patent usually occurs through application of adhesive to the rails. Hence, existing commercial products do not include any printed information or material in the areas of the rails, as the plies are not intended to be separable in these regions. No useful information is printed on the rails also because of the possibility that candling would permit discovery of that information.

However, tampering with labels may occur prior to their application to substrates or, if thereafter, prior to distribution of substrates to retail establishments or to consumers. In some circumstances, hence, there may be need to ascertain the validity of a game piece prior to separation of the plies of the piece by a consumer. Indeed, in some circumstances, validity of a game piece (particularly a winning one) might need to be determined prior to application of the piece on a substrate.

### SUMMARY OF THE INVENTION

The present invention provides information assisting a determination of validity of certain multi-ply labels prior to separation of the plies (either by a consumer or otherwise). Such information preferably is included in the area of the rails of one or more plies, notwithstanding that adhesive might also be contained in these areas. Further, the validity information beneficially is viewable—rather than hidden or wholly confused—when the labels are candled, facilitating determination of validity without separating or destroying the plies. Some confusion bits or noise could, however, be included as well to diminish the likelihood that laymen would understand the validity information.

A preferred embodiment of the invention includes information printed onto a rail of the intermediate of three plies utilized in a label. Such ply may correspond generally with the “second” ply of the labels of the Rich patent and preferably contains the principal game indicia associated with the label. Knowledge of the validity information, perhaps combined with other closely-held information, could be used to ascertain whether the corresponding game indicia on the ply is that of a winning game piece (and if so, what type of award is to be won).

Alternatively or additionally, validity information may be included elsewhere in the labels. Typically, however, it will be contained on the underside of the intermediate ply, where the principal game indicia also resides. The validity information may be as simple as one or more letters, numbers, or symbols (or a combination thereof), encoded or uncoded, although it may be a complex representation instead. Extraneous information (i.e. confusion-type noise) likewise may either be interspersed with the validity information or placed in corresponding rails of other plies of the labels.

In addition to game indicia and validity information, labels of the present invention may include additional graphics or text (or both). These graphics or text may be produced in any suitable manner, including via static or variable printing techniques. They may convey promotional information, explain game play or redemption rules, or entertain consumers, for example, or perform some other function as necessary or desired.

It thus is an optional, non-exclusive object of the present invention to provide labels having two or more plies.

It also is an optional, non-exclusive object of the present invention to provide labels including validity information.

It is a further optional, non-exclusive object of the present invention to provide multi-ply labels having separable central portions and rails adhered together.

It is another optional, non-exclusive object of the present invention to provide multi-ply labels having validity information presented in a rail portion of a ply.

It is, moreover, an optional, non-exclusive object of the present invention to provide labels having validity information presented on the same ply and face as is the principal game indicia.

It is yet another optional, non-exclusive object of the present invention to provide multi-ply labels in which validity information is discernable (as, for example, by candling the labels) without separation of the plies.

Other objects, features, and advantages of the present invention will be apparent to those skilled in the relevant art with reference to the remaining text and drawings of this application.

### BRIEF DESCRIPTION OF THE DRAWINGS

FIGS. 1A-B provide exploded views of an exemplary three-ply label of the present invention.

FIG. 2 provides a plan view of a ply of the label of FIG. 1.

### DETAILED DESCRIPTION

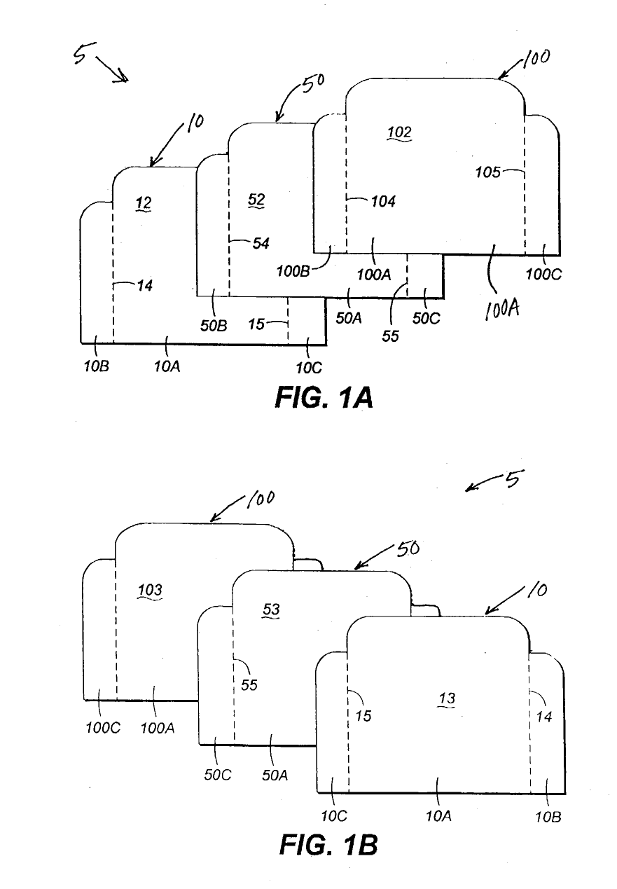

FIGS. 1A-B illustrate components of label 5 of the present invention. FIG. 1A presents the components of label 5 as viewed from above (and in front of) the label 5, with FIG. 1B presenting the components as viewed from below (and behind) label 5. In the exemplary version depicted in FIGS. 1A-B, label 5 comprises three plies: first, or base, ply 10, second, or game, ply 50, and third, or cover, ply 100. Each ply 10, 50, and 100 preferably has the same shape as the other plies, although this characteristic is not mandatory. Similarly, although a three-ply label 5 is depicted in FIGS. 1A-B, label 5 may have fewer (i.e. one or two) or more (i.e. four or more) plies than is shown in the drawings.

Each of plies 10, 50, and 100 additionally may define a face and an underside. Respective faces 12, 52, and 102 of plies 10, 50, and 100 are shown in FIG. 1A, for example, while corresponding undersides 13, 53, and 103 are depicted in FIG. 1B. The plies 10, 50, and 100 further may define respective central regions 10A, 50A, and 100A and respective pairs of rails 10B-C, 50B-C, and 100B-C.

Perforations 14 mark a boundary between central region 10A and rail 10B, while perforations 15 separate central region 10A from rail 10C. Similarly, one or more slits or perforations 54 and 55 separate central region 50A from, respectively, rails 50B and 50C. Boundaries between central region 100A and rails 100B and 100C are provided by perforations 104 and 105, respectively. As noted in the Rich patent, perforations 14 and 15 need not be present, as typically no separation of central region 10A from rails 10B-C need occur.

Adhesive frequently is present in multiple areas of label 5. Because base ply 10 is adapted to contact a substrate in use, its underside 13 may be provided with adhesive adequate to attach label 5 to the substrate. This is particularly true for underside 13 in the area of rails 10B-C; otherwise, sides of label 5 would be loose from the substrate and potentially available to be snagged when the substrate is handled. Avoiding snagging of labels 5 in the environments of fast-food restaurants is especially important, as the substrates (e.g. soft-drink cups, food wrappers, French fry containers) may be subjected to significant handling before being presented to consumers.

Adhesive likewise is present is the areas of rails 50B-C and 100B-C. To affix second ply 50 to base ply 10, for example, adhesive is placed on either face 12 or underside 53 (or both) in the areas of aligned rails 10B and 50B and 10C and 50C. Doing so attaches second ply 50 to base ply 10 while permitting removal of central region 50A, which is not itself affixed to central region 10A of base ply 10.

Similarly, affixing third ply 100 to second ply 50 may occur through placing adhesive on either face 52 or underside 103, or both, in the areas of aligned rails 50B and 100B and 50C and 100C. In some embodiments of label 5, face 52 further may include adhesive in the area of central region 50 so as to allow central region 50, after removal from the remainder of label 5, to be affixed to a board or card, for example, as part of the game. In these embodiments underside 103 of third ply 100 should include a release coat in the area of central region 100A. Regardless, however, because central regions 50A and 100A are aligned as part of label 5, they may be grasped and removed together by rupturing aligned sets of perforations 54 and 104 and 55 and 105.

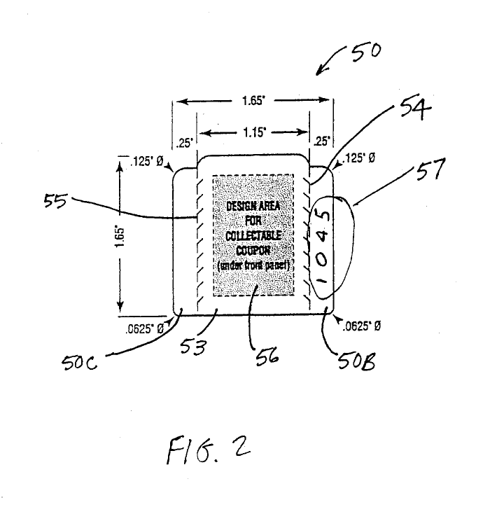

Game indicia 56 (see FIG. 2), or other information intended to be hidden from a consumer prior to removal of central regions 50A and 100A, often is printed onto underside 53 in central region 50A. Any opacity or confusion information provided by the substrate and base ply 10 thus protect against premature viewing of the game indicia 56 from behind label 5. Opacity or confusion patterns provided by third ply 100 and face 52 of second ply 50 similarly protect against premature viewing of the hidden information from in front of label 5.

Printed on face 102 of third ply 100 often is promotional information about the game or its sponsor (or both). One commercially-available game includes blue ink in most areas of face 102 together with the name of the game, the logo of its sponsor, and explanatory text such as “Pull Here,” “See Rules for Details,” and “No Purchase Necessary.” Persons skilled in the field will recognize that other, or different, information or graphics may be included on face 102 instead. (Although not preferred, face 102 alternatively may even consist of a single solid color or remain blank and unadorned.)

Unlike existing labels, validity information 57 may be incorporated into label 5. Such information 57 preferably is located on one or more of rails 50B or 50C on underside 53 and is printed using ink (or some other substance) adapted for use either atop adhesive present on rails 50B or 50C or notwithstanding later application of adhesive atop it. The information 57 similarly preferably is created simultaneously with printing of adjacent game indicia 56. If information 57 is unique (either to a particular game piece, a particular group of game pieces, or a specific prize level or type, for example), knowledge of information 57 may assist in ascertaining the validity of the indicia 56. In some cases, validity information 57 may be the only information needed to determine whether label 5 houses a particular set of game indicia 56. In many circumstances, however, validity information 57 may be necessary, but not sufficient, to discern the contents of label 5 without removing central regions 100A and 50A.

FIG. 2 illustrates, as validity information 57, the four-digit code “1045.” Such code is merely an example of information that may comprise validity information 57, however. Indeed, validity information may include any number of letters, numbers, symbols, colors, or other discernable features instead. Alternatively or additionally, validity information 57 may be wholly or partly machine-readable only and thus not necessarily completely discernable to a person.

Validity information 57 may be hidden from view in a manner similar to that used to hide game indicia 56. Beneficially, however, validity information 57 is not so hidden, but rather is viewable when label 5 is candled (for example). Thus, in appropriate circumstances information needed to verify the contents of label 5 may be gleaned through examination of validity information 57 without rupturing any of perforations 54, 55, 104, or 105.

Because preferably intelligible when label 5 is candled, validity information 57 usually will not be obscured significantly by confusion patterns or other confusion-type information potentially present on either underside 103 or face 52. Nevertheless, confusion-type information may be included, if desired, in the areas of rails 100B-C or 50B-C on either underside 103 or face 52. Any such included confusion-type information further may be decodable if desired, so that validity information 57 would be intelligible only through both candling and decoding.

Like any other text or graphics incorporated into label 5, validity information 57 may be imaged, printed, or otherwise placed on or engraved in ply 50 in any suitable manner. Validity information 57 alternatively or additionally may be incorporated into some portion of label 5 other than a rail 50B or 50C of second ply 50. (Indeed, in some cases validity information could be located in a central region 10A, 50A, or 100A or on a rail other than either of those associated with underside 53.) However, the fact that rails 50B and 50C conventionally contain adhesive, and conventionally lack any information whatsoever, make placement of validity information 57 there counterintuitive, enhancing its verification assistance.

The foregoing is thus provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention. In particular, any of rails 10B-C, 50B-C, or 100B-C need not necessarily be positioned at edges of respective plies 10, 50, or 100, but instead conceivably may be positioned elsewhere in some circumstances (in which event regions 10A, 50A, and 100A might or might not be “centrally” located on respective plies 10, 50, and 100). Validity information 57, alternatively, might be fake and designed to mislead potential tamperers rather than identify any characteristic of game indicia 56.

What is claimed is:

1. A promotional label comprising.
a. a game ply comprising first and second portions, the first portion containing game indicia and being separable from the second portion, and the second portion containing validity information related to the game indicia; and
b. a base ply comprising first and second portions, the second portion being adhered to the second portion of the game ply.

2. A promotional label according to claim 1 in which the second portion of the game ply contains adhesive.

3. A promotional label according to claim 2 further comprising a cover ply comprising first and second portions, the first portion containing promotional information and being separable from the second portion, and the second portion being adhered to the second portion of the game ply.

4. A promotional label according to claim 3 in which at least one of the second portion of the base ply or the second portion of the cover ply contains adhesive.

5. A promotional label according to claim 4 in which the validity information uniquely identifies at least one aspect of the game indicia.

6. A promotional label according to claim 4 in which the validity information is encoded.

7. A promotional label according to claim 4 in which the validity information must be utilized in connection with other information not contained on or in the label in order to identify the game indicia.

8. A promotional label according to claim 4 in which the validity information is viewable through the cover ply when the label is candled.

9. A promotional label according to claim 4 in which the game ply comprises at least one perforation allowing separation of its first portion from its second portion.

10. A promotional label according to claim 9 in which the first portion of the game ply comprises a central region and the second portion comprises a rail.

11. A promotional label according to claim 10 in which the game ply further comprises a third portion separable from its first portion.

12. A promotional label according to claim 11 in which (i) the base ply further comprises a third portion separable from its first portion and (ii) the third portion of the base ply is adhered to the third portion of the game ply.

13. A promotional label according to claim 1 in which the base ply defines an underside containing adhesive for attachment to a substrate in use.

14. A food or beverage container comprising a promotional label comprising:
a. a base ply affixed to the container,
b. a game ply comprising first and second portions, the first portion containing game indicia and being separable from the second portion, and the second portion being affixed to the base ply and containing validity information related to the game indicia; and
c. a cover ply comprising first and second portions, the first portion containing promotional information and being separable from the second portion, and the second portion being adhered to the second portion of the game ply.

15. A container according to claim 14 in which the second portion of the game ply further contains adhesive.

16. A method of ascertaining validity of one or more aspects of game indicia contained in a promotional label, the method comprising:
a. providing the promotional label, the promotional label comprising:
i. a game ply comprising first and second portions, the first portion containing game indicia and being separable from the second portion, and the second portion containing validity information related to the game indicia; and
ii. a ply covering the validity information;
b. candling the promotional label to view the validity information; and
c. comparing the viewed validity information with other information to ascertain the validity of one or more aspects of the game indicia.
